(19) United States
(12) Patent Application Publication
(10) Pub. No.: US 2005/0044506 A1
(43) Pub. Date: Feb. 24, 2005

(54) Updating information content on a small display

(75) Inventor: Mikko K. Makela, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/918,928

(22) Filed: Aug. 16, 2004

(30) Foreign Application Priority Data
Aug. 19, 2003 (FI) 20031169

(51) Int. Cl. G09G 5/00; G06K 9/54

(52) U.S. Cl. 715/801; 715/508; 715/788; 715/800

(57) ABSTRACT

A method for fitting information content comprised by an electronic document onto the display of an electronic device, formatting of the information content of the electronic document being originally adapted to be shown on a display larger than that of the electronic device. The electronic document is loaded to the memory of the electronic device, and the information content of the document is compared with the information content of another electronic document defined as a reference document. If the information content of the loaded electronic document differs from the information content of the reference document more than a predetermined limit value, the loaded electronic document is shown on the display of the electronic device in such a way that the first part to have information content that differs from the reference document more than the limit value is updated on the display.

### FIELD OF THE INVENTION

The invention relates to devices provided with small displays, and particularly to updating large information content on the display of a device.

### BACKGROUND OF THE INVENTION

The number of measures performed with a wireless terminal, such as a mobile station, has increased significantly as a result of the advance of the mobile station technology. A mobile station is no longer used merely for calls, but data can be processed and presented with a mobile station in a more and more varied manner. One of the most desired properties of a wireless terminal is the possibility to use Internet services, such as e-mail and graphic www pages. Also many other small portable terminals (what are called PDA devices) comprise means, for instance a WLAN card or a wired interface, for establishing an Internet connection.

The appearance and usability of nearly all graphic services in the Internet have been optimized in view of the large display of a desktop computer. Although many wireless computers, such as several mobile stations, comprise means for establishing an Internet connection, the typically small-sized displays of wireless terminals cause problems, particularly in the use of graphic services. For example 128×128/160 and 176×208 pixels are known resolutions of a mobile station display, while www pages are adapted for displays the resolution of which is, for instance, 800×600, 1024×768 or even 1280×960 pixels. This results in the display of a wireless terminal being capable of showing only a small part of the www pages at a time, which means that the user of the terminal receives only a little information at a time.

Browser programs (e.g. Web Viewer™) are available for some mobile stations, such as those utilizing Nokia® Series 60 platforms, these programs being capable of fitting the content of a www page onto the small display of a mobile station in such a way that the line width of the www page (e.g. 800, 1024 or 1280 pixels) is fitted onto more than one line (176 pixels) of the mobile station display, and the elements wider than the display, such as image files, are scaled to be of the width of the display. Thus, the page needs not be browsed in the horizontal direction, but in the vertical direction the page easily becomes very long, which makes the browsing difficult.

Further, the typical manner of designing www pages causes problems in connection with the above-described procedure. Www pages are typically designed in such a way that the title and control information of the pages appear on the upper lines of the page, while the so-called page navigation bar appears on the left side or at the top of the page. Thus, when the content of a www page is fitted onto the small display of a mobile station in the above manner by dividing the line width of a www page between several lines of the mobile station display, the information that typically remains the same on every page, i.e. title and control information and the buttons of the navigation bar, is always shown first on the display. If, for example, the user selects a link in the navigation bar, the www page behind the link is updated in the mobile station, but the user sees first on the display the same unchanged information as before the selection of the link. Thus, the user does not know whether the desired www page has been updated on the display but has to browse the page downwards to see this. In addition, the user does not know at which point on the page the new content has been updated but has to scroll down the display to find information and may still not see the updated information content.

### BRIEF DESCRIPTION OF THE INVENTION

A method and an apparatus implementing the method have been provided with which the clarity of information content updating can be improved on small displays. Different aspects of the invention are represented by a method, an electronic device and a computer program that are characterized by what is stated in the independent claims. Preferred embodiments of the invention are described in the dependent claims.

The invention is based on the idea that information content of an electronic document is fitted onto the display of an electronic device, the formatting of the information content being typically adapted to be shown on a display larger than this particular display in such a way that said electronic document is loaded to the memory of the electronic device, after which the information content of said electronic document is compared with the information content of another electronic document defined as a reference document. If the information content of said loaded electronic document differs from the information content of said reference document more than a predetermined limit value, said loaded electronic document is shown on the display of the electronic device in such a way that the first part to have information content that differs from the reference document more than the limit value is updated on the display.

An alternative embodiment involves a method for fitting information content of an electronic document onto the display of an electronic device, the formatting of which information content is adapted to be shown on a display larger than that of said electronic device. This method comprises receiving with an external server a downloading request presented by the electronic device for transmitting an electronic document to the device; comparing the information content of said electronic document defined in the downloading request with the information content of another document defined as a reference document; and, in response to the information content of said electronic document differing from the information content of said reference document more than a predetermined limit value, transmitting said electronic document and information on the first document part to have information content that differs from the reference document more than said limit value to the electronic device to be shown on its display.

In accordance with an embodiment of the invention, the information content of said electronic document is compared with the information content of the electronic document defined as a reference document and located in the cache of the browser program comprised by the electronic device or in the cache of the server.

In accordance with an embodiment of the invention, the preceding electronic document to have been shown on the display of the electronic device, located in the cache, is defined as the reference document.

In accordance with an embodiment of the invention, the information contents of said electronic document and said reference document are compared on the basis of the markup-language source code of the documents.

In accordance with an embodiment of the invention, the markup-language text element fields and the image elements the size of which exceeds a determined limit value in the documents are taken into account in the comparison.

In accordance with an embodiment of the invention, in response to a command given by the terminal user, the next part of said loaded electronic document to have information content that differs from the reference document more than the limit value is updated on the display of the electronic device.

In accordance with an embodiment of the invention, said loaded electronic document is shown miniaturized on the display of the electronic device, and, in response to a command given by the terminal user, the first part in said loaded electronic document to have information content that differs from the reference document more than said limit value is updated enlarged on the display of the electronic device.

In accordance with an embodiment of the invention, said loaded electronic document is shown on the display of the electronic device from the beginning in response to at least one of the following conditions:
the information content of said electronic document does not differ from the information content of said reference document more than the predetermined limit value;
the cache does not contain a document defined as a reference document; or
the domain address of said electronic document differs from the domain address of said reference document.

An advantage of the method and apparatus according to the invention is that since the display is updated automatically in such a way that information that is new compared with the reference document is brought to the display, a need for scrolling the display is decreased and the user is immediately able to get acquainted with the updated information. A further advantage is that the method gives the user an immediate intuitive response of whether the loading of the desired page was successful. An advantage of a preferred embodiment of the invention is that document comparison based on a markup-language source code is a very simple and straightforward way to implement a comparison algorithm which does not load the terminal much. An advantage of an alternative embodiment of the invention is that the comparison can be performed as early as in the network server, in which case the terminal receives, together with the loaded page, information on the part where the new document differs from the reference document.

### BRIEF DESCRIPTION OF THE FIGURES

The invention will now be described in more detail in connection with preferred embodiments, with reference to the attached drawings, of which:

FIG. 1 shows a block diagram of an electronic device to which the invention can be applied;

FIGS. 2a and 2b show, respectively, a www page designed for high display resolution, and that portion of the page which can be shown at a time on an essentially smaller display; and

FIG. 3 shows a flow chart of a procedure according to a preferred embodiment of the invention for updating the page automatically on the display.

### DETAILED DESCRIPTION OF THE INVENTION

FIG. 1 shows a general block diagram of a portable electronic device (ED), which may be, for instance, a wireless mobile station or a PDA (Personal Digital Assistant) device and to which the invention can be applied.

The electronic device (ED) comprises a central processing unit (CPU), memory (MEM) and an I/O system (I/O). All required information is stored in the memory (MEM) of the device. The memory (MEM) comprises a read-only memory portion that can be ROM memory, for example, and a write memory portion that can be formed of RAM (Random Access Memory) and/or FLASH memory, for example. Via the I/O system (I/O), the device communicates with, for example, other devices, the network and the user. A user interface (UI), which is part of the I/O system (I/O), comprises a required interface for communicating with the user, such as a display, keys, a loudspeaker and/or a microphone. The information received from different components of the device is transmitted to the central processing unit (CPU), which processes the received information in a desired manner.

Intelligent wireless terminals generally utilize a platform upon which terminal software can be created and which enables a variety of mobile station applications and services. The platform typically comprises a graphic user interface as well as applications and techniques, such as a multimedia messaging service (MMS), XHTML (Extensible Hypertext Markup Language) scanning and Java, structured upon the Symbian operating system, for example. The platform allows software providers, operators and device manufacturers to preferably create applications of their own upon it, which applications function between different devices and networks.

One platform generally used in mobile stations is Nokia® Series 60 Platform, brought into use also by many other mobile station manufacturers. The display size to be used in the Series 60 platform is specified as 176×208 pixels.

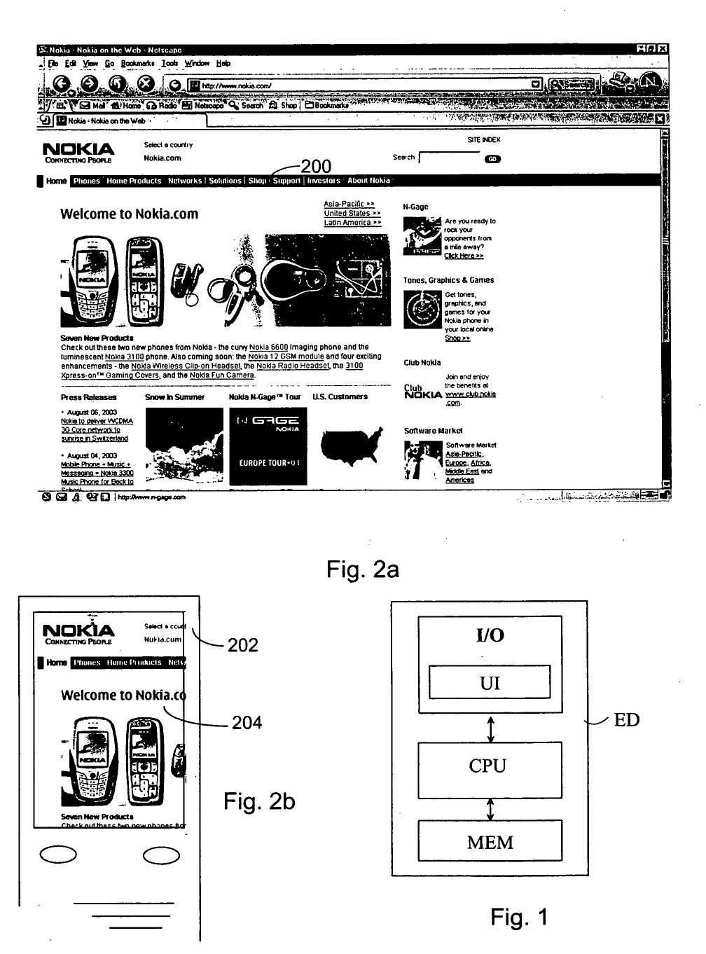

FIGS. 2a and 2b illustrate the limits of such a display when showing information content fitted onto a large display. FIG. 2a shows a www page designed for display resolution of 800×600 pixels. FIG. 2b shows substantially that portion of the page that can be shown at a time with display resolution of 176×208 pixels. Thus, FIG. 2b does not show how the page according to FIG. 2a would be downloaded in practice to the display of 176×208 pixels, because the manner of presentation is application-specific. The page can be shown in its original form without any optimization modifications, as shown in FIG. 2b, or the page can be optimized for instance in the above manner by dividing the line width of the page between several lines on the mobile station display. Upon optimization of the page, a navigation bar 200 at the top in FIG. 2a would typically be shown completely on the display of 176×208 pixels, which further reduces the space available for showing other information on the page at a time and increases the need for scrolling, due to which finding the desired information becomes more difficult. Also, only a small part of the www page updated behind the selected link is seen in addition to the navigation bar, whereby the user does not know in which part of the page the new desired content has been updated.

To solve this problem a procedure has been provided for updating the display automatically at the point of the new information content. In the procedure according to the invention, the downloaded page is updated on the display of a wireless terminal in such a way that if the information contents of the downloaded page of a browser program and of a previous, typically the preceding page of a reference document differ from each other sufficiently, the downloaded page is automatically updated on the display in such a way that the first part to have sufficiently changed information content is brought to the display. Preferably, this automatic positioning of information content does not require any measures from the part of the user. Automatic positioning can be carried out either in such a way that a new page is updated from the beginning, and after that, the display is scrolled down to the first part to have sufficiently changed information content, or in such a way that the first part to have sufficiently changed information content is updated directly on the display.

In accordance with a preferred embodiment of the invention, the user can update a page on the display automatically by activating a given function, for example by clicking a mouse or other pointer, in such a way that the next part to have sufficiently changed information content is brought to the display. In this way, the user can quickly browse through the changed parts of the page or document.

In accordance with a preferred embodiment of the invention, particularly the comparison of the information contents of www pages is performed between the information contents of the downloaded page and the preceding page in the cache of the browser program. Thus, the possible changes in the visual appearance of the pages are ignored in the comparison. This is particularly advantageous in the above-described solution, where the content of a normal-sized www page is fitted onto the small display of a mobile station in such a way that the line width of the www page is fitted on several lines on the mobile station display. In this case, page formattings must naturally be modified, but preferably this does not affect the comparison according to the invention.

In accordance with a preferred embodiment of the invention, the reference document does not have to be the preceding browsed page, but the comparison can be performed in relation to a basic page or document, which is preferably determined according to the page or directory structure. For example, when moving from document “a://aaa/aaa.html” to document “a://aaa/bbb.html”, the reference point is the basic document “a://index.html” of the site. In some cases such comparison may, because of the page or directory structure, be a more advantageous way to illustrate differences between documents.

In accordance with a preferred embodiment of the invention, the comparison is based on the markup-language source code of the pages, the contents of given elements on the pages being compared with each other. Typically, the www pages are defined as an HTML (HyperText Mark-up Language) source code, which contains element specifications for all text and image fields appearing on the pages and for their different formats. Thus, all text element fields and image elements shown on the display are taken into account in the comparison. It is to be noted that the procedure according to the invention is not restricted to HTML documents, but it can be applied to any structural documents the meta data of which enables comparison of document contents. Such documents include for instance XML (Extensible Markup Language) and XHTML (Extensible Hypertext Markup Language) files, as well as Microsoft® Word and Adobe® PDF documents. Also what are called rich text and plain text documents can be compared with each other in the above manner, which allows, for example, quick finding of recent changes in coach and train timetables. Thus, also the term “browser program” should, in this context, be interpreted broadly in such a way that it comprises not only www browsers that show HTML-based Internet pages and are conventionally regarded as browser programs, but also application programs, such as word processing programs, suitable for showing structural documents.

In accordance with a preferred embodiment of the invention, the comparison can be performed either in the terminal or in the downloading server of the network, or in both of them. For instance, A Web Viewer™ browser that fits the content of a normal-sized www page onto the small display of a mobile station by dividing the line width of the www page between several lines of the mobile station display utilizes an optimization server in the network, which server forms suitable www page formatting ready for a narrow display and thus speeds up downloading of the page. Preferably, also the preceding www page downloaded by the terminal and its source code are known to the optimization server. Thus, the above-described comparison can be performed as early as in the optimization server, and the new page can be provided with an indication on the part of the document where the first sufficiently changed information content is. The terminal can utilize this indication to update the changed information content on the display.

In accordance with a preferred embodiment of the invention, the server transmits to the terminal only the information that has changed compared with the preceding page, in response to which the browser program uses the preceding page as a template and updates these changed points on it. This preferably decreases network load, because the amount of data transmitted over the network is often essentially smaller than when a whole page is transmitted. The information on the changed information content can be transmitted by using, for example, “document fragment identifier” pointers conforming to HTML version 4.01, whereby the procedure according to the invention can be applied, by means of a server, to such browser programs, for instance old programs, that do not as such support the method.

In accordance with a preferred embodiment of the invention, the new page updated on the display of the terminal may first be presented according to the original page specifications, but sufficiently miniaturized, so that the width of the whole page can be fitted onto the narrow display. The user can then select from this miniature image a desired part for further viewing, whereby this part is shown sufficiently enlarged on the display, and possibly with the original lines divided between several narrow lines. Since it may be difficult to distinguish the changed information content from the miniature image, this can be indicated by highlighting on the display, for example by using a text with a different colour or background. Also, the cursor may automatically be taken to the point of the changed information, in which case the user can have this information, if desired, enlarged on the display only by activating a cursor function.

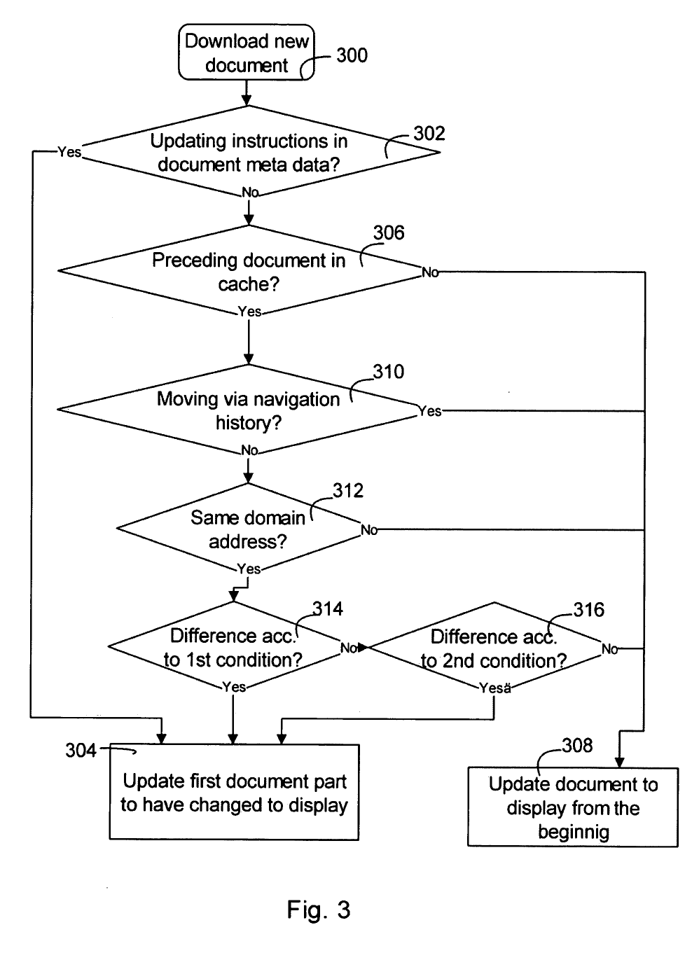

The procedure according to the invention for updating the page automatically is illustrated next by way of example, with reference to the flow chart of FIG. 3. FIG. 3 only shows one example of a comparison algorithm and the comparison criteria used in it. It will be obvious to a person skilled in the art that the same inventive idea can be implemented with a plurality of different comparison algorithms and comparison criteria.

The starting point for the procedure of FIG. 3 is a function executed by the terminal user in a browser program for downloading a new page to be shown with the browser program (300). The function executed by the user may be, for example, activating a hyper link on the preceding page (e.g. by clicking the link with a pointer) or writing the URL address of a new page in the address field of the browser program.

Downloading a new page starts a comparison algorithm, which is executed before or at the same time as the new page is brought to the display. It is thus possible to initially show the new page from the beginning, and after it is determined which part of the new page should be shown first (determined by metadata or comparison), the page is automatically scrolled to that part. This can preferably be carried out in such a way that if the user starts navigating the page while the determination is in progress, determination is cancelled and no automatic scrolling will be done. The first step (302) of the comparison algorithm is to check whether the meta data of the downloaded page comprises instructions for updating the page on the display. Comparison of the pages may have been performed in the above manner in the optimization server, which has provided the new page with an indication of the changed information content or transmitted only the changed information content without other data comprised by the page. Thus, the browser program updates the new page on the display according to the updating instructions in such a way that the first part on the new page to have changed information content is updated substantially at the top of the terminal display (304). However, the meta data for updating the page on the display is not necessarily added by the optimization server but may already be in the original documents. In this case, no comparisons are made, but meta data from the original documents is obeyed instead.

If the meta data of the document-does not comprise updating instructions, one moves on to the following step (306) of the comparison algorithm, where it is checked whether the preceding page has been stored to the cache of the browser program. If the preceding page is not in the cache, no comparison between the new and the preceding page can be performed, and the new page is shown on the display in such a way that its beginning is visible on the terminal display (308) and the rest of the page can be made visible by scrolling down the display.

If the preceding page has been stored in the cache, it is checked next whether the moving to the new page took place by means of the navigation history of the browser program (310), in other words whether the new page is one of the previous pages of the same connection, whereby the moving can take place for instance by means of “back/forward” commands of the browser program. If the navigation history is used in the moving, comparison between the pages is not carried out, but the page is displayed at the point at which the browsing stopped the preceding time (308).

If the preceding page has been stored in the cache and no navigation history is used when moving to the page, and no metadata telling which part of the page should be shown first exists, the following step is to check whether the new page and the preceding page have the same domain address (312). If the domain addresses differ from each other, also the contents of the pages are very likely to differ from each other, whereby it is logical to show the new page on the display from the beginning (308). Some service providers have, in different places in the network, what are called mirror sites that are each other's (nearly identical) copies and that are used for reducing the network load in connection with the downloading of the same information content. The domain addresses of the mirror sites may differ from each other, but they are so rare that, with regard to the comparison algorithm, it is simpler to assume the contents of different domain addresses to be different.

The page to be downloaded may comprise a definition that prevents permanent storing of the page in the cache of the browser program, whereby, when exiting from the page, the page cannot be found in the cache any longer. However, this problem can be avoided in such a way that also said pages are stored in the cache for comparison in such a way that each time one moves again to the page in question, the page is re-downloaded from the network. Some www pages, for example, use what are called scripts (e.g. Java/ECMAScript) for generating information content. In such a case, the preceding page must be processed in the comparison in the format in which it would be after executing the scripts. The comparison to be performed can preferably be made more efficient by storing the page instead of or in addition to the original source code in some format that is optimized for the comparison.

If the new page and the preceding page have the same domain address, the comparison of the information contents of the pages is performed relative to the first comparison criteria (314). The first comparison criteria are preferably set in such a way that the page contents must be sufficiently different in order to affect the updating of the new page on the display. The comparison is preferably performed based on the markup-language, for instance HTML-language, source code of the pages, whereby the contents of given elements are compared between the pages. The comparison preferably concerns only the information content of the pages, whereby possible changes in the visual appearance of the pages, for example, are ignored in the comparison. Thus, the starting point is that in the text content and in the sufficiently large image files, for example, the changes are taken into account.

In the first comparison, the criterion for a sufficient difference may be, for instance, that the new page comprises a sequence of at least eight successive words which differs from the preceding page stored in the cache. Each new image file differing from the preceding page can be calculated as four words, for instance. In this case, too, a restriction may be set according to which images smaller than 30×30 pixels, for example, are not taken into account, because they typically relate to page formatting and presentation settings and do not as such affect the information content of the page. Correspondingly, a sufficiently large image file may be interpreted as eight words, whereby it alone is interpreted as a sufficiently big change. When, for example, HTML-language source codes are compared, all text element fields and text-format hyperlinks (<a>) as well as all image elements (<img>), selection elements (<select>) and object elements (<object>) shown on the display are taken into account, observing the restriction of 30×30 pixels mentioned above. If in the first comparison (314) a sufficient difference according to the first criteria is detected, the new page is updated on the page in such a way that the first part of the new page to have said sufficient difference is updated substantially at the top of the terminal display (304). Thus, the downloaded page is updated on the display automatically in such a way that the first part to have sufficiently changed information content is highlighted, whereby the user immediately notices the difference compared with the preceding page. The user can naturally browse the page in any direction from the part updated on the display.

If in the first comparison no sufficient difference, for example eight successive words, according to the first criteria is detected between the pages second comparison can preferably be performed according to second comparison criteria (316). In this comparison, for example any change in the information content, such as a new image, can be interpreted as a sufficiently big change, whereby a new page is shown in such a way that its first part to have changed information content is substantially at the top of the display (304). If no change between the pages is found in the second comparison either, a new page is shown in such a way that its beginning is substantially at the top of the display (308).

In accordance with a preferred embodiment of the invention, search for a part having changed information content can be implemented not only with an algorithm based on the examination of the document source code but also by utilizing pattern recognition, in which case also the information content of images, for example, can be observed better in the comparison, and defining image differences is not based merely on comparing the titles and sizes of image files.

Thus, functionality according to the invention in a portable terminal can most preferably be implemented as a browser application, which is implemented as a computer program. When executed in the central processing unit CPU, the browser application causes the terminal to implement measures according to the invention. Most preferably, the computer program can be implemented as a plug-in loaded to the terminal or to be in connection with the browser program. Functions of the computer program SW can be divided between several separate software components communicating with each other. The computer program can be stored in any memory means, for instance on the hard disk of a PC or on a CD-ROM, from where it can be loaded into the memory MEM of a mobile station MS. The computer program can also be downloaded via the network, for instance by using the TCP/IP protocol stack. Also hardware solutions and a combination of hardware and software solutions can be used for implementing the inventive means.

Thus, the computer program SW preferably comprises a computer program code portion for comparing the information content of said electronic document with the information content of the preceding electronic document to have been shown on the display of the electronic device; and a computer program code portion for showing said loaded electronic document on the display in such a way that the first part of said loaded electronic document to differ from the information content of said preceding electronic document more than the predetermined limit value is updated on the display.

In addition, the above-described properties of the optimization server according to the invention can most preferably be implemented as a computer program. Thus, this computer program preferably comprises a computer program code portion for receiving a downloading request presented by the electronic device for transmitting an electronic document to the device; a computer program code portion for comparing the information content of said electronic document defined in the downloading request with the information content of the preceding electronic document transmitted to the electronic device; and a computer program code portion for transmitting said electronic document and information on the first document part to have information content differing from the reference document more than said limit value to the electronic device to be shown on its display.

It will be obvious to a person skilled in the art that with the advance of technology, the basic idea of the invention can be implemented in a plurality of ways. The invention and its embodiments are thus not restricted to the above examples but can vary within the scope of the claims.

1. A method for fitting information content comprised by an electronic document onto the display of an electronic device, formatting of the information content of the electronic document being adapted to be shown on a display larger than that of said electronic device, the method comprising
loading said electronic document to the memory of the electronic device;
comparing the information content of said electronic document with the information content of another electronic document defined as a reference document; and
in response to the information content of said loaded electronic document differing from the information content of said reference document more than a predetermined limit value,
showing said loaded electronic document on the display of the electronic device in such a way that the first part to have information content that differs from the reference document more than the predetermined limit value is updated on the display.

2. A method for fitting information content comprised by an electronic document onto the display of an electronic device, formatting of the information content of the electronic document being adapted to be shown on a display larger than that of said electronic device, the method comprising
receiving with an external server a downloading request presented by the electronic device for transmitting an electronic document to the device;
comparing the information content of said electronic document defined in the downloading request with the information content of another electronic document defined as a reference document; and
in response to the information content of said electronic document differing from the information content of said reference document more than a predetermined limit value,
transmitting said electronic document and information on the first document part to have information content that differs from the reference document more than said limit value to the electronic device to be shown on its display.

3. A method according to claim 1, further comprising
comparing the information content of said electronic document with the information content of the electronic document defined as a reference document and located in the cache of a browser program comprised by the electronic device or in the cache of the server.

4. A method according to claim 3, further comprising
defining the preceding electronic document to have been shown on the display of the electronic device, located in the cache, as the reference document.

5. A method according to claim 1, further comprising
comparing the information contents of said electronic document and said reference document on the basis of the markup-language source code of the documents.

6. A method according to claim 5, further comprising
taking into account, in the comparison, the markup-language text element fields and the image elements the size of which exceeds the predetermined limit value in the documents.

7. A method according to claim 1, further comprising in response to a command given by the terminal user,
updating on the display of the electronic device the next part of said loaded electronic document to have information content that differs from the reference document more than said limit value.

8. A method according to claim 1, further comprising
showing said loaded electronic document miniaturized on the display of the electronic device; and
in response to a command given by the terminal user,
updating enlarged on the display of the electronic device the first part of said loaded electronic document to have information content that differs from the reference document more than said limit value.

9. A method according to claim 1, further comprising
showing said loaded electronic document on the display of the electronic device from the beginning in response to at least one of the following conditions:
the information content of said electronic document does not differ from the information content of said reference document more than the predetermined limit value;
the cache does not contain a document defined as a reference document; or
the domain address of said electronic document differs from the domain address of said reference document.

10. An electronic device comprising:
a substantially small-sized display;
a browser program for fitting the information content comprised by the electronic document onto said display;
means for loading said electronic document to the memory;
means for comparing the information content of said electronic document with the information content of another electronic document defined as a reference document; and
means for showing said loaded electronic document on the display in such a way that the first part of said loaded electronic document to differ from the information content of said reference document more than a predetermined limit value is updated on the display.

11. An electronic device according to claim 10, wherein
said means for comparing the information content is arranged to compare the information content of said electronic document with the information content of the electronic document defined as a reference document and located in the cache of a browser program comprised by the electronic device or in the cache of the server.

12. An electronic device according to claim 11, further comprising
means for defining the preceding electronic document to have been shown on the display of the electronic device, located in the cache, as the reference document.

13. An electronic device according to claim 10, wherein
said means for comparing the information content is arranged to compare the information contents of said electronic document and said reference document on the basis of the markup-language source code of the documents.

14. An electronic device according to claim 13, wherein
said means for comparing the information content is arranged to take into account the markup-language text element fields and the image elements the size of which exceeds the predetermined limit value in the documents.

15. An electronic device according to claim 10, further comprising
means for updating, responsive to a user command, on the display of the electronic device the next part of said loaded electronic document to have information content that differs from the reference document more than said limit value.

16. An electronic device according to claim 10, wherein
said means for showing said loaded electronic document is arranged to show said loaded electronic document miniaturized on the display of the electronic device; and
in response to a command given by the terminal user,
said means for updating is arranged to update enlarged on the display of the electronic device the first part of said loaded electronic document to have information content that differs from the reference document more than said limit value.

17. An electronic device according to claim 10, wherein
said means for showing said loaded electronic document is arranged to show said loaded electronic document on the display of the electronic device from the beginning in response to at least one of the following conditions:
the information content of said electronic document does not differ from the information content of said reference document more than the predetermined limit value;
the cache does not contain a document defined as a reference document; or
the domain address of said electronic document differs from the domain address of said reference document.

18. A computer program product arranged, when loaded to an electronic device, to control fitting of the information content of an electronic document loaded to the memory of the electronic device onto the display of the electronic device; the computer program product comprising
a computer program code portion for comparing the information content of said electronic document with the information content of another electronic document defined as a reference document; and
a computer program code portion for showing said loaded electronic document on the display in such a way that the first part of said loaded electronic document to have information content differing from the information content of said reference document more than a predetermined limit value is updated on the display.

19. A computer program product according to claim 18, wherein
said computer program code portion for comparing the information content further includes a computer program code portion for comparing the information content of said electronic document with the information content of the electronic document defined as a reference document and located in the cache of a browser program comprised by the electronic device or in the cache of the server.

20. A computer program product according to claim 19, further comprising
a computer program code portion for defining the preceding electronic document to have been shown on the display of the electronic device, located in the cache, as the reference document.

21. A computer program product according to claim 18, wherein
said computer program code portion for comparing the information content further includes a computer program code portion for comparing the information contents of said electronic document and said reference document on the basis of the markup-language source code of the documents.

22. A computer program product according to claim 21, wherein
said computer program code portion for comparing the information content further includes a computer program code portion for taking into account the markup-language text element fields and the image elements the size of which exceeds the predetermined limit value in the documents.

23. A computer program product according to claim 18, further comprising
a computer program code portion for updating, responsive to a user command, on the display of the electronic device the next part of said loaded electronic document to have information content that differs from the reference document more than said limit value.

24. A computer program product according to claim 18, wherein
said computer program code portion for showing said loaded electronic document further includes a computer program code portion for showing said loaded electronic document miniaturized on the display of the electronic device; and
said computer program code portion for updating further includes a computer program code portion for updating, responsive to a user command, enlarged on the display of the electronic device the first part of said loaded electronic document to have information content that differs from the reference document more than said limit value.

25. A computer program product according to claim 18,
said computer program code portion for showing said loaded electronic document further includes a computer program code portion for showing said loaded electronic document on the display of the electronic device from the beginning in response to at least one of the following conditions:
the information content of said electronic document does not differ from the information content of said reference document more than the predetermined limit value;
the cache does not contain a document defined as a reference document; or
the domain address of said electronic document differs from the domain address of said reference document.

26. A network element arranged to fitting information content comprised by an electronic document onto the display of an electronic device, formatting of the information content of the electronic document being adapted to be shown on a display larger than that of said electronic device; the network element comprising
means for receiving a downloading request presented by the electronic device for transmitting an electronic document to the device;
means comparing the information content of said electronic document defined in the downloading request with the information content of another electronic document defined as a reference document; and
means for transmitting said electronic document and information on the first document part to have information content that differs from the reference document more than a predetermined limit value to the electronic device to be shown on its display.
